(19) United States
(12) Patent Application Publication
(10) Pub. No.: US 2019/0317278 A1
(43) Pub. Date: Oct. 17, 2019

(54) DIRECTIONAL COUPLER AND METHOD FOR DESIGNING THE SAME

(71) Applicant: NEC Corporation, Minato-ku, Tokyo (JP)

(72) Inventor: Naoki KOBAYASHI, Tokyo (JP)

(73) Assignee: NEC Corporation, Minato-ku, Tokyo (JP)

(21) Appl. No.: 16/470,635

(22) PCT Filed: Dec. 19, 2017
(86) PCT No.: PCT/JP2017/045452

§ 371 Date: Jun. 18, 2019

(30) Foreign Application Priority Data
Dec. 28, 2016 (JP) 2016-255370

(51) Int. Cl. G02B 6/125; G02B 6/12; G02B 6/293; G02B 27/00

(52) U.S. Cl. CPC G02B 6/125; G02B 6/12007; G02B 6/29338; G02B 2006/12135; G02B 27/0012; G02B 2006/12147; G02B 6/29395

(57) ABSTRACT

The purpose of the present invention is to improve gap tolerance in a directional coupler. Toward that purpose, this directional coupler has two waveguides facing across a gap, the directional coupler being characterized in that a desired gap and directional coupler length are provided from among gaps and directional coupler lengths in which the branch ratio of the directional coupler is at the maximum or in the vicinity of the maximum, a difference being provided in the propagation coefficients of the two waveguides in the coupling region to achieve the desired branch ratio.

### TECHNICAL FIELD

The present invention relates to a directional coupler and a method for designing the same.

### BACKGROUND ART

In optical communication in recent years, reinforcement of optical communication lines has been strongly required as communication traffic increases. Integration of optical function elements has been actively examined in order to reinforce the optical communication lines. Regarding the integration of optical function elements, integration of optical waveguide-type filters is one of important issues. Such an optical waveguide-type filter will be described next.

As examples of the optical waveguide-type filter, a Mach-Zehnder interferometer (MZI interferometer) and a ring resonator are mentioned, and the both are composed of a directional coupler (DC). This is because the directional coupler has a function to branch light. The directional coupler exerts a branch function in such a manner that two optical waveguides (hereinafter, abbreviated as waveguides) are optically coupled to each other. In order to couple light, a waveguide interval (gap) is set equal to or less than a waveguide width in terms of dimension. The gap always varies due to a manufacturing error occurring in a manufacturing process, and accordingly, a branch ratio also has variations. As a result, variations occur in characteristic of the optical waveguide-type filter, and eventually, characteristics of the whole of an integrated optical element vary. Hence, it is extremely important to suppress the variations of the branch ratio of the directional coupler. A reason why the branch ratio varies is described next in detail.

As a premise, conceived is a directional coupler including two waveguides 1 and 2 of which circumferences are surrounded by a cladding 3 as illustrated in FIG. 1. FIG. 2 illustrates cross-sectional structures of the waveguides in the vicinity of the center (where the gap is the smallest) of the directional coupler. Generally, the two waveguides 1 and 2 are often set to have the same dimension, and accordingly, the directional coupler will also be described herein on the assumption that the two waveguides 1 and 2 have the same dimension. The branch ratio of the directional coupler is defined by FIG. 3. In other words, when a part (X) of light that has intensity 1 and passes through a certain waveguide is branched to an adjacent waveguide, the branch ratio is X. The branch ratio takes a value from 0 to 1. It is additionally noted that, though the term branch ratio is used in this description, this is sometimes described by a term coupling efficiency in other literature.

In the above-mentioned structure in which the dimensions of the two waveguides are the same, the branch ratio is determined by a DC length and a gap. As one example, FIG. 4 illustrates a change of the branch ratio when the DC length is taken as a parameter. The branch ratio periodically changes in accordance with the DC length, and moreover, changes in a smaller cycle as the gap is narrower. In addition, the following is seen from FIG. 4. It is seen that, while a fluctuation of the branch ratio is extremely small when the DC length is shifted by 0.1 um with respect to a certain target DC length due to a process error or the like, the branch ratio changes greatly when the gap is shifted by 0.1 um with respect to a target thereof. More specifically, it can be said that tolerance (degree of allowance) for a dimensional fluctuation of the gap is severer than that for a dimensional fluctuation of the DC length. Usually, a target value of the branch ratio of the directional coupler is often set to approximately 0.1 to 0.3, and accordingly, the tolerance is studied under conditions where 0.2 is assumed as the target value of the branch ratio and an allowable process error of the branch ratio is ±10% (hence, the branch ratio is 0.20±0.02). FIG. 5 is a graph in which the gap is taken on an axis of abscissas and the branch ratio when the DC length is set constant is plotted. In order that the branch ratio can remain within 0.20±0.02, the gap must be set to 0.50±0.01 um. In the manufacturing process technology as of 2016, process tolerance of a generally commercially available device is approximately 0.03 um, and it is extremely difficult to stably achieve 0.01 um. Therefore, yield degradation due to a process error has been previously unavoidable.

Patent Literature 1 (PTL1) discloses a waveguide-type optical branching element in which widths of two optical waveguides which constitute a directional coupler are made different from each other to change propagation constants thereof. In this element, the propagation constants are differentiated from each other, whereby wavelength dependency of a coupling rate is relieved.

### CITATION LIST

### Patent Literature

[PTL1] Japanese Patent Application Laid-Open No. Hei2-287408
[PTL2] Japanese Patent Application Laid-Open No. Hei6-110091

### Non Patent Literature

[NPL1] OKAMOTO Katsunari, “Fundamentals of Optical Waveguides (Photonics Series)”, Corona Publishing Co., Ltd., 1992, pp. 131 to 132

### SUMMARY OF INVENTION

### Technical Problem

In a directional coupler mentioned with reference to FIG. 1, regarding the branch ratio of the directional coupler for use in an integrated type optical function element, a degree of allowance (process tolerance) for an error of a gap dimension in the manufacturing process is extremely small. Therefore, there has been a problem of poor yield since the directional coupler cannot be stably manufactured. There is no description about the process tolerance for the gap in PTL1.

An object of the present invention is to improve the tolerance for the gap.

### Solution to Problem

The present invention relates to a directional coupler in which two waveguides faces each other with a gap interposed therebetween, wherein the directional coupler is provided with a desired gap and directional coupler (DC) length among gaps and DC lengths in which a branch ratio of the directional coupler becomes maximum or a vicinity thereof, and a desired branch ratio is obtained by differentiating propagation constants of the two waveguides in a coupling region from each other.

The present invention relates to a directional coupler in which two waveguides couples to each other with a ring resonator interposed therebetween, wherein the directional coupler is provided with a desired gap and DC length among gaps and DC lengths in which a branch ratio of the waveguides and a ring resonator becomes maximum or a vicinity thereof, and a desired branch ratio is obtained by differentiating propagation constants of coupling regions of the waveguides and the ring resonator.

The present invention relates to a method for designing a directional coupler provided with a directional coupler in which two waveguides face each other with a gap interposed therebetween, the method including:

selecting a desired gap and DC length from among gaps and DC lengths in which a branch ratio of the directional coupler becomes maximum or a vicinity thereof; and

obtaining a desired branch ratio by differentiating propagation constants of the two waveguides in a coupling region from each other.

### Advantageous Effects of Invention

According to the present invention, it becomes possible to improve tolerance for a gap in a directional coupler.

### BRIEF DESCRIPTION OF DRAWINGS

FIG. 1 is a plan view of an existing directional coupler composed of two waveguides.

FIG. 2 is a diagram illustrating cross-sectional structures of the waveguides in the vicinity of the center of the directional coupler in FIG. 1 (where a gap therebetween is the smallest).

FIG. 3 is a plan view explaining a branch ratio of the directional coupler.

FIG. 4 is a diagram illustrating a change of the branch ratio when a DC length is taken as a parameter.

FIG. 5 is a diagram for explaining tolerances for a gap and a DC length in a region where a value of a target branch ratio is small.

FIG. 6 is a diagram for explaining tolerances for a gap and a DC length in a region where the value of the target branch ratio is large.

FIG. 7 is a plan view of a directional coupler according to a first example embodiment of the present invention.

FIG. 8 is a cross-sectional view of the directional coupler according to the first example embodiment of the present invention.

FIG. 9 is a diagram illustrating gap tolerance when a maximum value of the branch ratio is set to 0.2 in the first example embodiment of the present invention.

FIG. 10 is a plan view of a directional coupler according to a second example embodiment of the present invention.

FIG. 11 is a plan view of the directional coupler according to the second example embodiment of the present invention.

### EXAMPLE EMBODIMENT

### (First Example Embodiment)

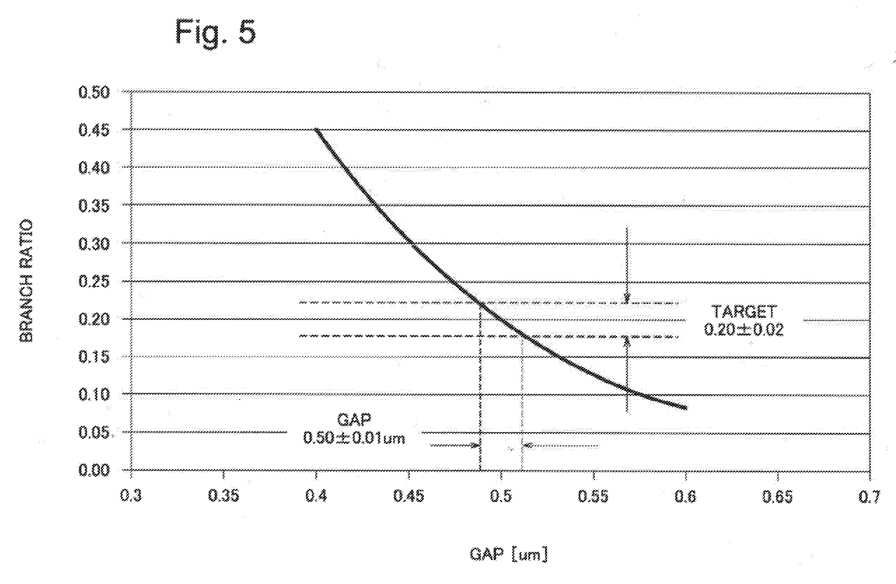

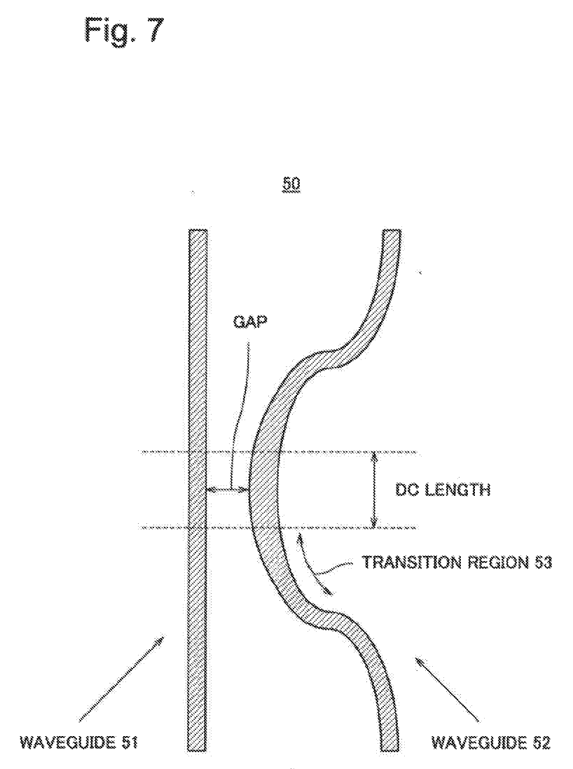

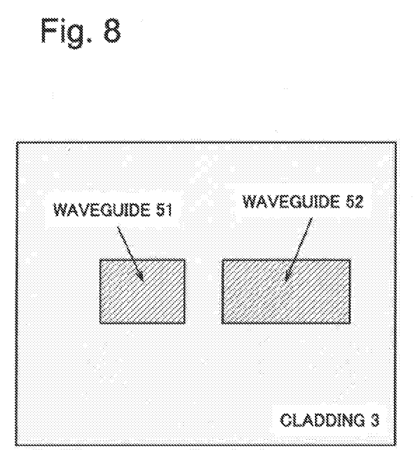

A first example embodiment of the present invention will be described by using FIGS. 5 to 8. FIG. 7 illustrates a plan view of a directional coupler 50 according to the present example embodiment. FIG. 8 is a cross-sectional view of a coupling region. The directional coupler 50 constitutes a planar optical waveguide-type filter.

Two waveguides 51 and 52 of which circumferences are surrounded by a cladding 3 are disposed on a substrate. A part of the waveguide 52 is bent and approaches the waveguide 51, and is optically coupled thereto at such an approaching portion, whereby the directional coupler 50 is constituted. The waveguide 52 has a larger width than the waveguide 51 at a coupling region 54 thereof with the waveguide 51 (FIG. 8), and in this region, has a different propagation constant from that of the waveguide 51. The waveguide 52 has the same width as that of the waveguide 51 in regions other than the above. In a boundary between the large width region and the same width region, there is a transition region 53 of which width is gradually changed. As a material of the waveguides 51 and 52, a semiconductor such as silicon or silicon oxide nitride (SiON) can be used, and as a material of the cladding, silicon dioxide (SiO₂) or the like can be used.

The directional coupler 10 according to the present example embodiment is designed in such a way as to satisfy the following (1) and (2), thereby expanding tolerance of a gap.
(1) A gap and a DC length in a region in which a branch ratio becomes maximum or a vicinity thereof are used.
(2) Propagation constants of two waveguides are made different from each other.
   Regarding that (1) a Gap and a DC Length in a Region in which a Branch Ratio becomes Maximum or a Vicinity thereof are Used

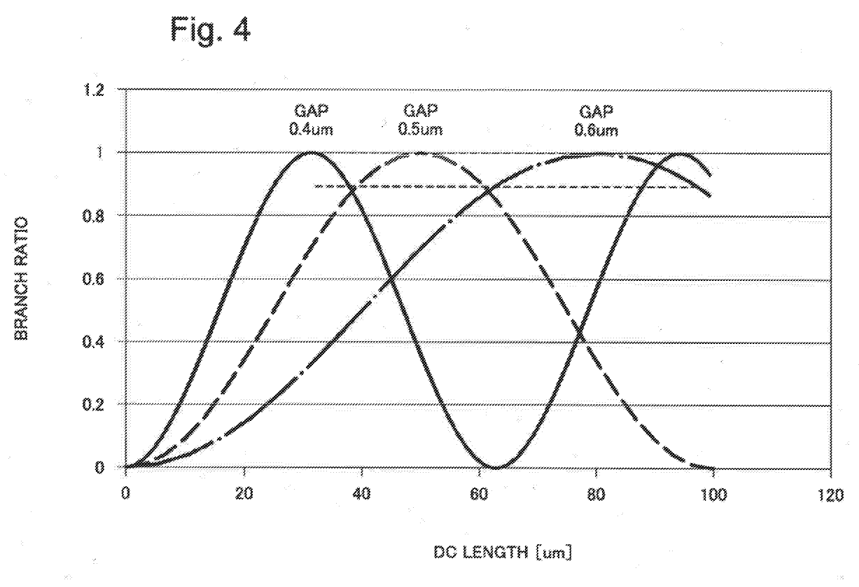

As mentioned above, the branch ratio of the directional coupler 50 of the present example embodiment uses a gap and a DC length as parameters. In a region where a value of a target branch ratio is small, the tolerance of the gap tends to become small (FIG. 4). In other words, when the branch ratio is attempted to be reduced, it is necessary to increase dimensional accuracy of the gap.

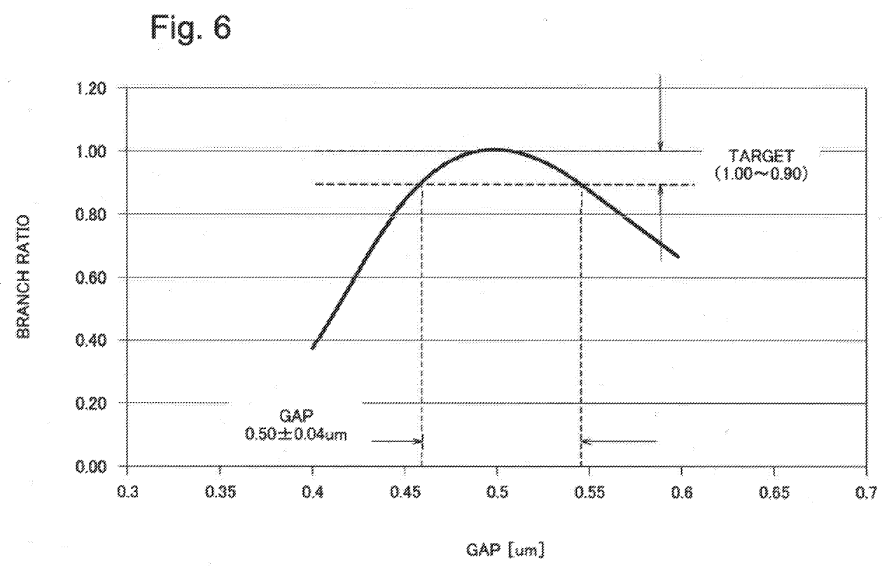

On the contrary, the tolerance becomes maximum in regions where the branch ratio is large, specifically, regions where the branch ratio is 1 and a vicinity thereof. This is illustrated in FIG. 6. In order to discuss the tolerance, an allowable error of the branch ratio is set to 10% as in the above-mentioned example (hence, the branch ratio is 1.00 to 0.90). In this case, an allowable error of the gap is ±0.04 um. When it is considered that the tolerance in the above-mentioned example is ±0.01 um, the tolerance can be expanded to approximately four times. However, this is merely in the case where the branch ratio is 1. As the branch ratio, 0.1 to 0.3 is usually used, and accordingly, it is desirable that the branch ratio be set within this range. (FIGS. 5 and 6 are the same in terms of illustrating the tolerance of the gap of the directional coupler including two waveguides; however, objects thereof are different from each other. FIG. 5 illustrates a case where the DC length is short in order to aim the branch ratio of 0.2, and FIG. 6 illustrates a case where the DC length is long in order to aim the branch ratio of 1. Therefore, a tendency of change of the branch ratio with respect to the gap is different between FIG. 5 and FIG. 6.)

Regarding that (2) Propagation Constants of Two Waveguides are made Different from Each Other

Accordingly, a maximum value of the branch ratio is adjusted while holding the tolerance mentioned above in (1) as much as possible. The maximum value of the branch ratio is determined by a difference in propagation constant between the two waveguides which constitute the directional coupler [NPL1: pp. 131 to 132]. Since the propagation constants are determined in accordance with dimensions of the waveguides, such a propagation constant difference becomes 0 when the dimensions of the two waveguides are the same. When the propagation constant difference is 0, the maximum value of the branch ratio becomes 1. The maximum value of the branch ratio is reduced as the propagation constant difference becomes larger. When the difference between the propagation constants is extremely large, the maximum value of the branch ratio becomes substantially 0, and the directional coupler does not have the branch function.

Considering this characteristic, the dimensions of the two waveguides just need to be determined by obtaining the propagation constant difference in such a way that the maximum value of the branch ratio becomes 0.2. In order to make a difference between the dimensions of the two waveguides, conceived are methods of changing a thickness direction of the waveguides and a lateral direction thereof (a width direction of the waveguides). However, in a usual manufacturing process, the method of changing the dimensions in the lateral direction is simpler. FIGS. 7 and 8 illustrate an example of different dimensions set in the lateral direction. In determining the dimensions, it is necessary to determine the propagation constants of the two waveguides and the difference between the propagation constants. Here, the difference between the propagation constants is determined by a target value of the branch ratio, and the propagation constants are determined by other requirements. For example, the other requirements are an upper limit number of propagation modes in the waveguides, process limitations, and properties of the materials for use. When the propagation constants are determined, the waveguide dimensions are determined.

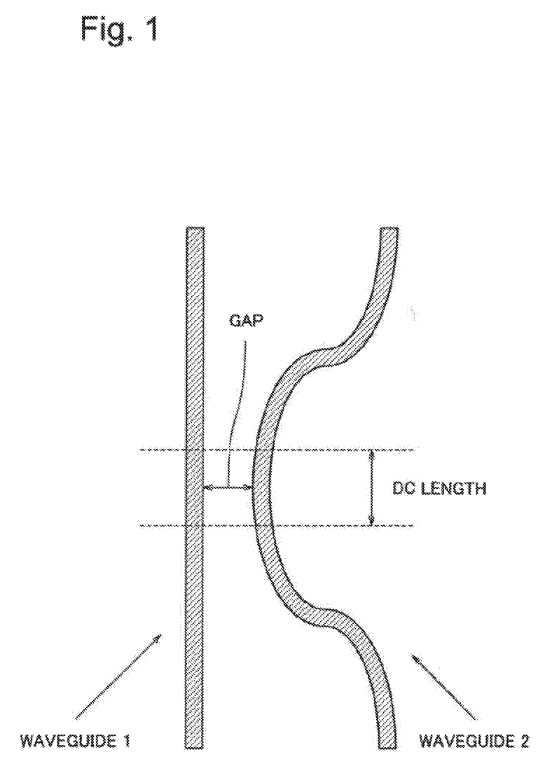

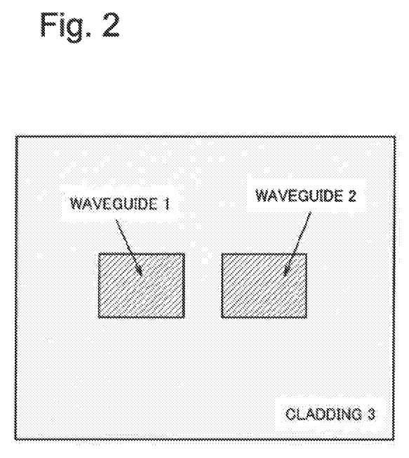

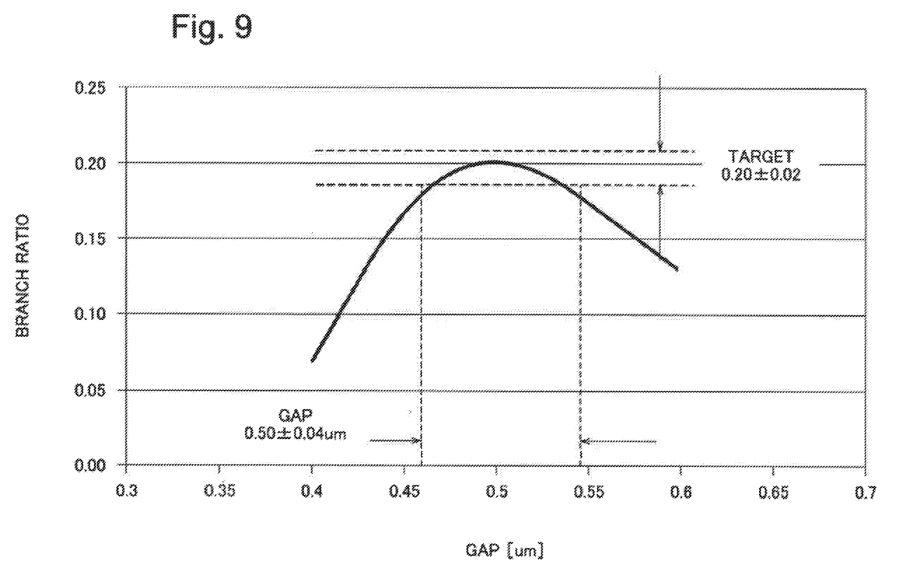

When the propagation constants are different from each other, then strictly speaking, there is a possibility that a deviation may occur a little from a fluctuation cycle of the above-mentioned branch ratio. In other words, when the maximum value of the branch ratio changes by the fact that the propagation constant changes, the fluctuation cycle of the branch ratio changes slightly. However, since the change of the branch ratio vs the gap in the vicinity of the maximum value keeps gentle, the fluctuation cycle is hardly affected. Therefore, the fluctuation cycle may be considered not to change. FIG. 9 illustrates gap tolerance when the maximum value of the branch ratio is 0.2. In the directional coupler mentioned in FIG. 1, the allowable tolerance of the gap is ±0.01 um in order to bring the branch ratio into the range of 0.20±0.02; however, the allowable tolerance of the gap can be expanded to ±0.04 um in the present example embodiment. ±0.04 um is the above-mentioned allowable error of the gap under the current situation, and it is seen that the present example embodiment tremendously expands the process tolerance regarding the gap of the directional coupler. As a result, it becomes possible to greatly improve a yield.

Note that, at the time of designing the directional coupler according to the present example embodiment, the gap and the DC length at which the branch ratio is maximized are used. However, since there is a manufacturing error, there is a possibility that a combination of the gap and the DC length of the actually manufactured directional coupler may not always achieve values at which the branch ratio is maximized and may be settled to values as vicinities thereof. However, in the case where the branch ratio obtained by the combination of the gap and the DC length after the manufacture is brought into the range of the allowable tolerance, then this case is incorporated in the present example embodiment. Moreover, even when the directional coupler is designed while slightly shifting the gap and the DC length from combination at which the branch ratio is maximized, in the case where the value of the branch ratio obtained by the combination of the gap and the DC length after the manufacture is brought into the range of the allowable tolerance, then this case is also incorporated in the present example embodiment.

Moreover, in FIG. 8, the width of the waveguide 52 as a branch destination is made larger than the width of the waveguide 51 as a branch source. However, on the contrary, the width of the waveguide 51 as a branch source is made larger than the width of the waveguide 52 as a branch destination, whereby a difference may be made between the propagation constants.

Moreover, in FIGS. 7 and 8, while the thicknesses of the waveguides 51 and 52 are kept equal to each other, only the widths thereof are differentiated from each other, whereby the difference is made between the propagation constants. However, only the thicknesses are differentiated from each other while the widths are kept equal to each other, or both of the widths and the thicknesses are differentiated from each other, whereby a difference may be made between the propagation constants.

Moreover, though the previous description describes the tolerance expansion regarding the gap; however, in the present structure, it is supplemented that the tolerance can be also expanded regarding each of the DC length and an operating wavelength. A reason why the tolerance can also be expanded regarding the DC length and the operating wavelength will be described below. Light is not trapped only in the waveguides, but seeps to and propagates through the cladding. A portion from which light seeps senses another waveguide, whereby branch of light occurs. The branch is more likely to occur as a seepage amount of light is larger. The matter that the directional coupler is tolerant means that the seepage amount of light is hardly variable. When a tolerant design is performed with respect to the DC length, i.e., when such a design as mentioned above in which the branch ratio is hardly variable is performed, then the design in which the seepage amount of light is hardly variable is performed.

Moreover, the seepage amount of light also changes depending on the operating wavelength; however, the directional coupler is also tolerant for the operating wavelength when the directional coupler is designed in such a way that the seepage amount is hardly variable.

In comparison with a quartz-based waveguide, it is possible to miniaturize the Si waveguide, and meanwhile, it is difficult to ensure manufacturing tolerance therein. However, according to the present example embodiment, it becomes possible to improve the tolerance for the gap in the directional coupler. As a result, it becomes possible to improve the yield. Moreover, in the present example embodiment, the tolerance is improved not only for the gap but also for the DC length and the operating wavelength. The directional coupler according to the present example embodiment can be used, for example, in a used wavelength region of approximately 0.2 um to 10 um for optical communication.

### (Second Example Embodiment)

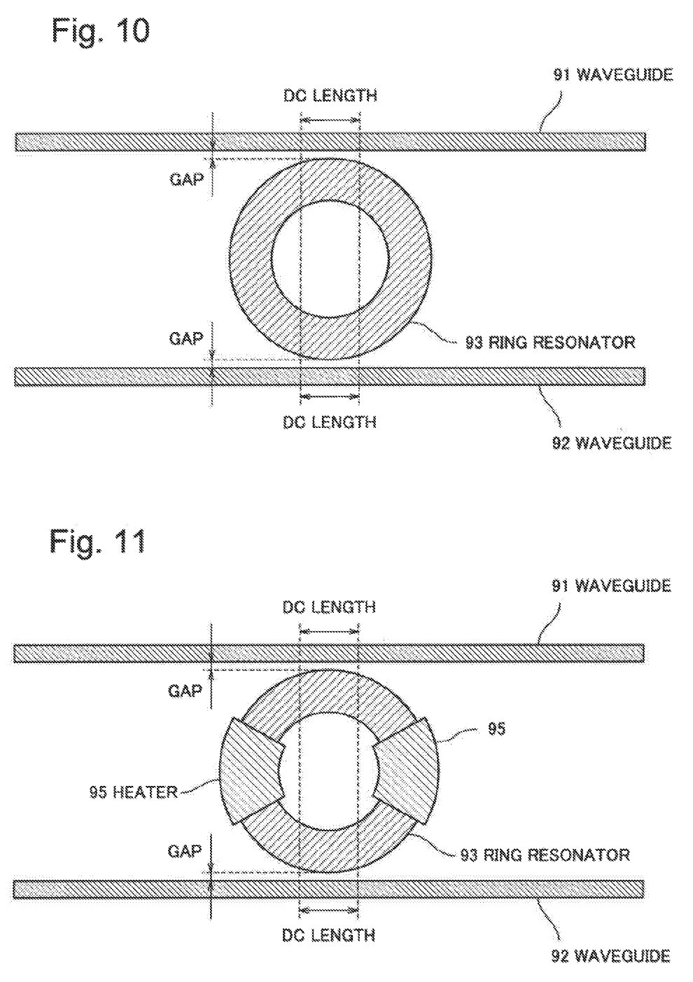

In the first example embodiment, the propagation constants of the two waveguides are made different. In a directional coupler according to a second example embodiment, as illustrated in FIG. 10, a ring resonator 93 is disposed between a waveguide 91 and a waveguide 92, and a propagation constant of the ring resonator 93 and a propagation constant of the waveguides 91 and 92 are differentiated from each other. In order that the propagation constants are differentiated from each other, for example, a width of the ring resonator 93 is made larger than a width of the waveguides 91 and 92. It is not necessary to differentiate the propagation constants of the waveguide 91 and the waveguide 92 from each other.

In the case of the present example embodiment, those which correspond to the gap and the DC length mentioned in the directional coupler according to the first example embodiment are gaps (two spots) between the ring resonator 93 and the waveguides 91 and 92 and a length of curved portions (two spots) where coupling occurs with the waveguides 91 and 92.

In the present example embodiment also, among gaps and DC lengths in which a branch ratio between the ring resonator 93 and the waveguides 91 and 92 is maximized, a desired gap and DC length are selected, and further, in order to lower the branch ratio to 0.1 to 0.3, the width of the ring just needs to be made larger than the width of the waveguides to thereby differentiate the propagation constants of the ring resonator 93 and the waveguides 91 and 92 from each other. This is the same as in the first example embodiment.

Note that, though the propagation constants of the ring resonator 93 and the waveguides 91 and 92 may be differentiated from each other by making the width of the ring resonator 93 smaller than the width of the waveguides 91 and 92, it is preferable to thicken the ring resonator 93 since only the ring needs to be thickened and the waveguides 91 and 92 do not need to be changed. Accordingly, the thickening of the ring resonator 93 can reduce a size of the directional coupler.

Moreover, in usual, heaters 95 are formed immediately above the ring at two spots as illustrated in FIG. 11. Specifically, metal film heaters are partially formed above the ring with SiO₂ films or the like interposed therebetween, and both ends of the metal film heaters are connected to a heating power supply (not illustrated). A change of characteristics of the ring when being heated is more likely to occur as a width of the ring is larger. A reason why the change of characteristics of the ring is likely to occur as the ring is thicker is due to trapping of light. As mentioned above, light is not entirely in the waveguides, but propagates while also seeping to the cladding (a). When Si or SiON is assumed as a material of the waveguides and SiO₂ is assumed as a material of the cladding, Si or SiON has a larger thermo-optic coefficient (a coefficient representing a degree to which a refractive index changes by heat) than SiO₂ (b). A thermo-optic coefficient of a waveguide including a core and a cladding is determined from (a) and (b). As light is in a core with a higher thermo-optic coefficient, the thermo-optic coefficient of the waveguide is increased. To make the width of the ring larger means to strengthen the trapping of light, and accordingly, the thermo-optic coefficient is increased.

Note that, though the ring resonator 93 having a circular plane shape is used in FIG. 10, the ring resonator 93 may be replaced by a resonator having a shape of a race track for athletics. In that case, the ring resonator 93 may be optically coupled to the waveguides 91 and 92 in linear portions of the race track, or alternatively, the race track may be disposed in such a way as to be erected, and the ring resonator 93 may be optically coupled to the waveguides 91 and 92 at curved portions of the erected race track.

### (Third Example Embodiment)

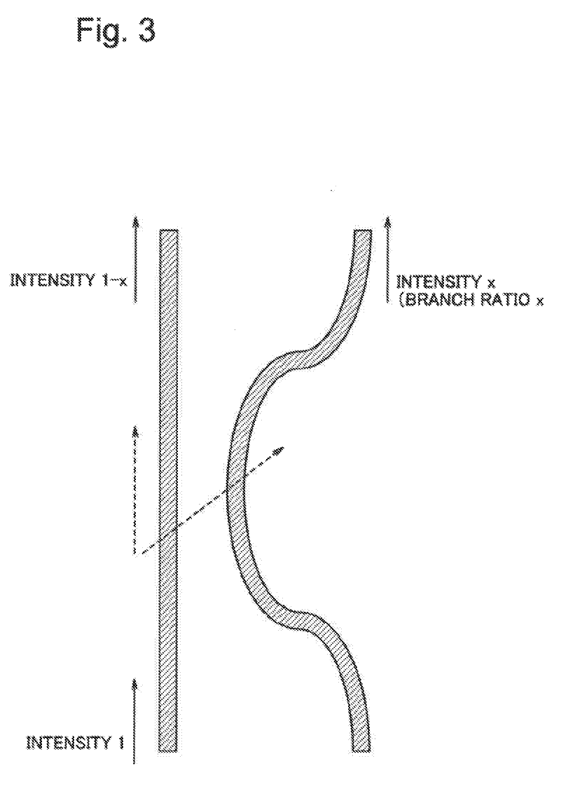

In the present example embodiment, a method for designing a directional coupler will be described. The directional coupler is designed according to the following procedures (i) and (ii).
(i) From among gap widths and DC lengths in which a branch ratio becomes maximum (=1) or a vicinity thereof (FIG. 4), a combination in which a desired gap width and DC length are obtained is selected. As present in FIG. 4, since the fluctuation cycle of the branch ratio with respect to the DC length is lengthened as the gap width is larger, an advantage is brought in terms of the gap tolerance. However, meanwhile, since the DC length is lengthened, a disadvantage is brought in terms of the miniaturization of the directional coupler. Hence, at the time of design, the combination of the gap width and the DC length is determined in balance with required tolerance, a usable area, and restrictions of the manufacturing process.
(ii) Two waveguides (FIG. 3, FIG. 7) in the coupling region are given the propagation constant difference to be adjusted to a desired branch ratio.

As mentioned in the first example embodiment, when the maximum value of the branch ratio is changed by changing propagation constant, the fluctuation cycle of the branch ratio changes slightly. However, the change of the branch ratio vs the gap in the vicinity of the maximum value keeps gentle, and accordingly, the fluctuation cycle is hardly affected thereby. Therefore, the fluctuation cycle may be considered not to change. When the design is made as described above, there is obtained a directional coupler in which the gap width and the DC length are of desired values and the tolerance of the gap is improved.

The present invention has been described above while taking the above-mentioned example embodiments as typical examples. However, the present invention is not limited to the above-mentioned example embodiments. In other words, a variety of modes understandable by those skilled in the art can be applied to the present invention within the scope of the present invention.

This application is based upon and claims the benefit of priority from Japanese Patent Application No. 2016-255370, filed on Dec. 28, 2016, the disclosure of which is incorporated herein in its entirety by reference.

### INDUSTRIAL APPLICABILITY

The directional coupler of the present invention can be used for the optical waveguide-type filter such as a ring resonator and an MZI interferometer, a wavelength variable laser using the optical waveguide-type filter as an external resonator, or the like.

### REFERENCE SIGNS LIST

1, 2, 51, 52, 91, 92 Waveguide

3 Cladding

50 Directional coupler

53 Transition region

54 Coupling region

93 Ring resonator

95 Heater

What is claimed is:

1. A directional coupler comprising two waveguides facing each other with a gap interposed therebetween, wherein the directional coupler is provided with a desired gap and directional coupler (DC) length among gaps and DC lengths in which a branch ratio of the directional coupler becomes maximum or a vicinity thereof, and a desired branch ratio is obtained by differentiating propagation constants of the two waveguides in a coupling region from each other.

2. The directional coupler according to claim 1, wherein, in the vicinity, the branch ratio obtained by the gap and DC length remains within a range of allowable tolerance.

3. The directional coupler according to claim 1, wherein the two waveguides are different from each other in terms of at least one of a width and a thickness.

4. A directional coupler comprising two waveguides coupling to each other with a ring resonator interposed therebetween, wherein the directional coupler is provided with a desired gap and DC length among gaps and DC lengths in which a branch ratio of the waveguides and a ring resonator becomes maximum or a vicinity thereof, and a desired branch ratio is obtained by differentiating propagation constants of coupling regions of the waveguides and the ring resonator.

5. The directional coupler according to claim 4, wherein the waveguides and the ring resonator are different from each other in terms of at least one of a width and a thickness.

6. The directional coupler according to claim 4, wherein a heater that heats the ring resonator is provided.

7. The directional coupler according to claim 1, wherein the waveguides are semiconductor waveguides.

8. A method for designing a directional coupler provided with a directional coupler in which two waveguides face each other with a gap interposed therebetween, the method comprising:
selecting a desired gap and DC length from among gaps and DC lengths in which a branch ratio of the directional coupler becomes maximum or a vicinity thereof; and
obtaining a desired branch ratio by differentiating propagation constants of the two waveguides in a coupling region from each other.
